(19) United States
(12) Patent Application Publication
(10) Pub. No.: US 2007/0046731 A1
(43) Pub. Date: Mar. 1, 2007

(54) Liquid ejection apparatus and ejection control method

(75) Inventor: Sho Onozawa, Ashigara-Kami-Gun (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/512,222

(22) Filed: Aug. 30, 2006

(30) Foreign Application Priority Data
Aug. 31, 2005 (JP) 2005-252053

(51) Int. Cl. B41J 2/05

(52) U.S. Cl. 347/61

(57) ABSTRACT

The liquid ejection apparatus comprises: an ejection port through which liquid is ejected; a heating device which is arranged near the ejection port; an ultrasonic wave generating element which generates and applies an ultrasonic wave to the liquid near the ejection port so as to be ejected through the ejection port; and a switching control device which switches between ejection of a cluster of droplets of the liquid through the ejection port and ejection of an individual droplet of the liquid through the ejection port, by changing temperature of the liquid near the ejection port by means of the heating device.

### BACKGROUND OF THE INVENTION

1. Field of the Invention

The present invention relates to a liquid ejection apparatus and a liquid ejection control method, and more particularly, to a liquid ejection apparatus and a liquid ejection control method capable of ejecting a cluster of very fine liquid droplets in the form of a mist.

2. Description of the Related Art

A liquid ejection head which ejects fine liquid droplets in the form of a mist, is known (see, for example, Japanese Patent Application Publication Nos. 62-85948, 62-111757, 10-278253, and 2002-166541).

Stated in simple terms, the ejection of mist is performed by creating a mist of the liquid by reducing the surface tension of the liquid by means of an ultrasonic wave. More specifically, in general, atomization caused by cavitation (hollowing), and atomization caused by capillary surface waves, are used. If the latter type of method is used, then it is possible to generate a mist of uniform particle size, and the energy efficiency is good.

In the capillary wave atomization, when a planar wave is applied in the direction of the free liquid surface, then provided that the frequency of the ultrasonic wave (planar wave) and the amplitude (onset amplitude) of the ultrasonic wave on the liquid surface at the meniscus in a nozzle satisfy particular conditions relating to the properties of the liquid, then the surface tension wave at the meniscus oscillates in a time series, and consequently, very small liquid droplets (mist) break away from the wave peaks of the surface tension wave at the meniscus, at certain time points.

The liquid ejection apparatuses which eject mist by using an ultrasonic wave have been able to eject only mist in the related art.

More specifically, ink mist ejection is suitable if forming an image which requires representation of tonal graduations having very fine tonal differences (for example, an image which creates a high-quality effect, such as a picture), but in the case of an image that requires no tonal graduations (for example, a row of characters), it is not possible to avoid deterioration of the quality in the case of the ink mist ejection.

### SUMMARY OF THE INVENTION

The present invention has been contrived in view of these circumstances, an object thereof being to provide a liquid ejection apparatus and a liquid ejection control method whereby a mist ejection mode and an individual droplet ejection mode can be set depending on whether or not representation of tonal graduations is required.

In order to attain the aforementioned object, the present invention is directed to a liquid ejection apparatus, comprising: an ejection port through which liquid is ejected; a heating device which is arranged near the ejection port; an ultrasonic wave generating element which generates and applies an ultrasonic wave to the liquid near the ejection port so as to be ejected through the ejection port; and a switching control device which switches between ejection of a cluster of droplets of the liquid through the ejection port and ejection of an individual droplet of the liquid through the ejection port, by changing temperature of the liquid near the ejection port by means of the heating device.

According to the present invention, the temperature of the liquid near the ejection port is controlled by using the heating device, thereby adjusting the viscosity of the liquid near the ejection port, and therefore it is possible to set a mist ejection mode or an individual droplet ejection mode, depending on whether or not representation of tonal graduations is required.

In order to attain the aforementioned object, the present invention is also directed to a liquid ejection apparatus, comprising: an ejection port through which liquid is ejected; an

ultrasonic wave generating element which generates and applies an ultrasonic wave to the liquid near the ejection port so as to be ejected through the ejection port; and a switching control device which switches between ejection of a cluster of droplets of the liquid through the ejection port and ejection of an individual droplet of the liquid through the ejection port, by changing a drive signal applied to the ultrasonic wave generating element.

According to the present invention, by controlling the drive signal applied to the ultrasonic wave generating element which generates the ultrasonic wave, it is possible to set a mist ejection mode or an individual droplet ejection mode, depending on whether or not representation of tonal graduations is required.

In order to attain the aforementioned object, the present invention is also directed to a liquid ejection control method, comprising the steps of: choosing one of ejection of a cluster of droplets of liquid through an ejection port and ejection of an individual droplet of the liquid through the ejection port; and switching between the ejection of the cluster of droplets of the liquid through the ejection port and the ejection of the individual droplet of the liquid through the ejection port, by changing temperature of the liquid near the ejection port, according to a result of the choosing step.

In order to attain the aforementioned object, the present invention is also directed to a liquid ejection control method, comprising the steps of: choosing one of ejection of a cluster of droplets of liquid through an ejection port and ejection of an individual droplet of the liquid through the ejection port; and switching between the ejection of the cluster of droplets of the liquid through the ejection port and the ejection of the individual droplet of the liquid through the ejection port, by changing a drive signal applied to an ultrasonic wave generating element which generates and applies an ultrasonic wave to the liquid near the ejection port so as to be ejected through the ejection port, according to a result of the choosing step.

According to the present invention, it is possible to set a mist ejection mode and an individual droplet ejection mode depending on whether or not representation of tonal graduations is required, and therefore, images of high quality can be formed.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a cross-sectional diagram showing an embodiment of the basic composition of a liquid ejection head;

FIGS. 2A to 2C are illustrative diagrams showing typical examples of amplitude patterns of surface tension waves at a meniscus of liquid;

FIG. 3 is a graph showing the relationship between the viscosity of the liquid and the onset amplitude;

FIG. 4 is a plan view perspective diagram showing the overall structure of a concrete embodiment of the liquid ejection head;

FIG. 5 is an enlarged diagram showing an enlarged view of a portion of FIG. 4;

FIG. 6 is a plan view perspective diagram showing the overall structure of a further concrete embodiment of the liquid ejection head;

FIG. 7 is a partial block diagram showing an approximate view of the general composition of an image forming apparatus corresponding to a liquid ejection apparatus according to an embodiment of the present invention;

FIG. 8 is a flowchart showing a sequence of an image forming process in which the liquid ejection control method according to an embodiment of the present invention is applied;

FIG. 9 is a general compositional diagram showing the functional composition of an image forming apparatus; and

FIG. 10 is a principal plan diagram of the peripheral area of a liquid ejection unit in the image forming apparatus in FIG. 9.

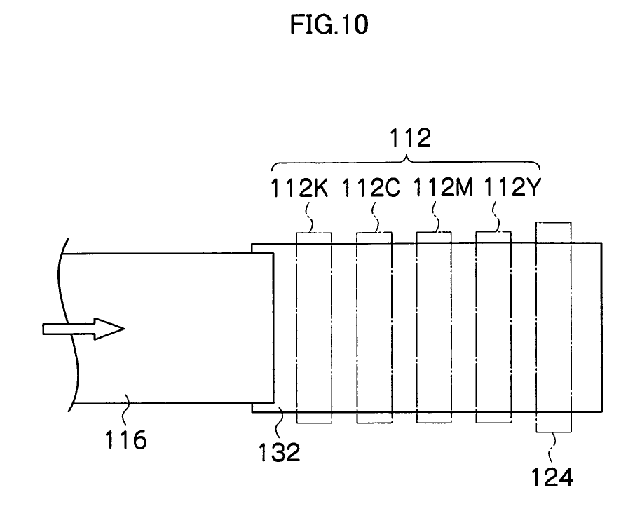

### DETAILED DESCRIPTION OF THE PREFERRED EMBODIMENTS

Basic Composition of Liquid Ejection Head

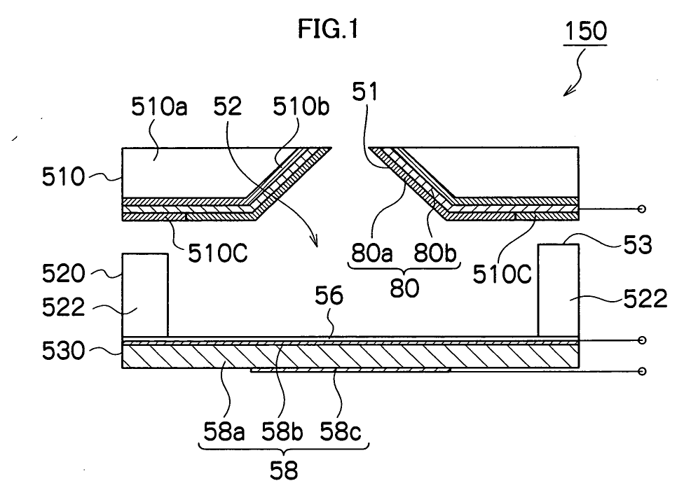

FIG. 1 is a cross-sectional diagram showing an embodiment of the basic composition of a liquid ejection head of an image forming apparatus to which the liquid ejection apparatus according to the present invention is applied.

In FIG. 1, the liquid ejection head 150 comprises: a nozzle (ejection port) 51, which is an opening through which liquid is ejected; a liquid chamber 52 connected to the nozzle 51; a liquid supply port 53, which is an opening through which the liquid is supplied to the liquid chamber 52; an ultrasonic wave generating element 58, which is fixed to a diaphragm 56 disposed on the bottom surface of the liquid chamber 52 and is an actuator generating an ultrasonic wave and applying the ultrasonic wave to the liquid inside the liquid chamber 52; and a heater 80, which is disposed near the nozzle 51 and heats the liquid near the nozzle 51 to change the temperature of the liquid so as to change the viscosity of the liquid.

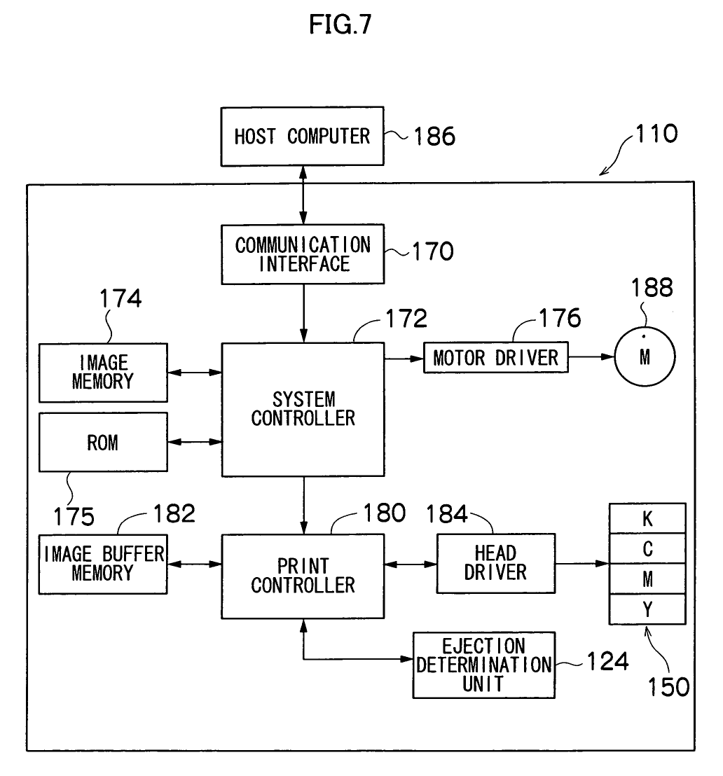

The ultrasonic wave generating element 58 includes a piezoelectric body layer 58a, and electrode layers 58b and 58c (hereinafter simply referred to as “electrodes”) to which a drive signal is applied from outside the liquid ejection head 150 (more specifically, from the head driver 184 in FIG. 7, described hereinafter).

The heater 80 includes a heat generating layer 80a, which converts the electrical energy into thermal energy, and an electrode layer 80b (hereinafter simply referred to as “electrode”) to which a drive signal is applied from outside the liquid ejection head 150 (more specifically, from the head driver 184 in FIG. 7, described hereinafter).

The liquid ejection head 150 has a laminated structure composed of a nozzle plate 510 formed with the nozzle 51 and the heater 80, a liquid chamber plate 520 formed with the liquid chamber 52, and an actuator plate 530 formed with the ultrasonic wave generating element 58.

The liquid chamber 52 is defined by the nozzle plate 510 serving as the ceiling plate, the actuator plate 530 serving as the bottom surface plate, and partitions 522 serving as side surface plates.

More specifically, the nozzle plate 510 includes a heat insulating layer 510b formed on a surface (the lower surface) of a substrate 510a, the electrode layer 80b formed on the heat insulating layer 510b, and the heat generating layer 80a formed on the electrode layer 80b. A heat insulating layer 510c is formed in the region of the nozzle plate 510 in which the heat generating layer 80a is not formed. Furthermore, although not shown in the drawing, it is also possible to form a protective film which prevents corrosion due to the ink, on the surface of the heat generating layer 80a, according to requirements.

For example, the substrate 510a is made of silicon (Si), the heat insulating layer 510b is made of silica (SiO₂), the electrode layer 80b of the heater 80 is made of nickel (Ni), and the heat generating layer 80a of the heater 80 is made of tantalum silicon oxide (TaSiO).

In the ultrasonic wave generating element 58, for example, the piezoelectric body layer 58a is made of lead zirconate titanate (Pb(Zr, Ti)O₃ (PZT)), the electrode layers 58b and 58c of are made of nickel (Ni), and the diaphragm 56 is made of polyimide (PI).

The vibrations generated by the ultrasonic wave generating element 58 fixed to the diaphragm 56 are introduced into the liquid inside the liquid chamber 52 through the diaphragm 56, and the vibrations progress as parallel planar waves towards the nozzle plate 510. By means of these planar waves, surface tension waves are established on the meniscus of the liquid in the nozzle 51. These surface tension waves are dependent on the surface tension of the liquid.

As stated above, the heater 80 is disposed near the nozzle 51, and the mode in which the liquid is ejected from the nozzle 51 (ejection mode) varies depending on whether or not the liquid near the nozzle 51 has been heated by the heater 80. In other words, the temperature of the liquid near the nozzle 51 is changed by the heater 80, and the viscosity of the liquid near the nozzle 51 changes accordingly. Therefore, the state of the surface tension waves can be changed, and hence the ejection modes of the liquid can be switched.

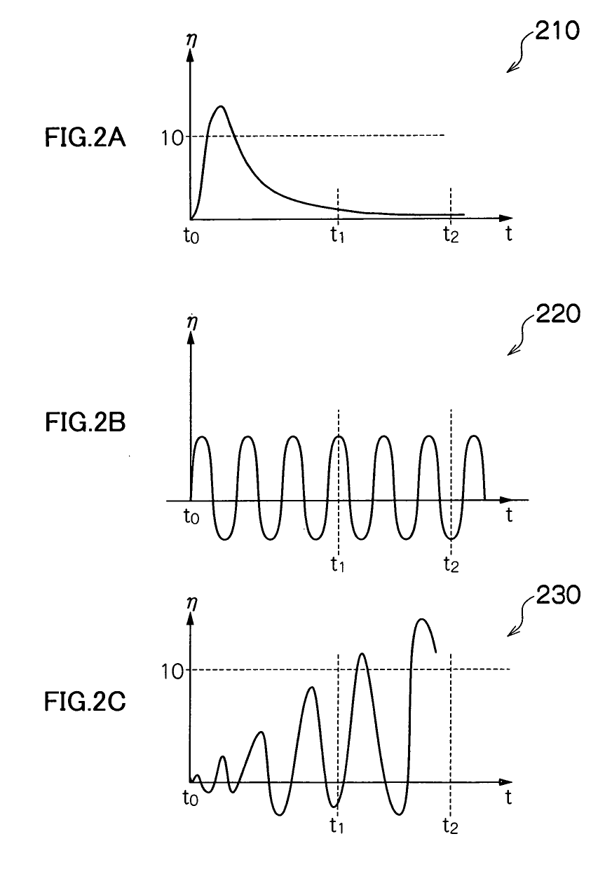

FIGS. 2A, 2B and 2C show typical examples of the correspondences between the amplitude of the surface tension wave at the meniscus of the liquid in the nozzle 51 and time (in other words, the amplitude pattern of the surface tension wave). In FIGS. 2A to 2C, the horizontal axis indicates time, t, and the vertical axis indicates the amplitude factor η.

The first amplitude pattern 210 shown in FIG. 2A is an amplitude pattern of overdamped oscillation, in which the liquid surface in the nozzle 51 is once excited within a prescribed cycle in the drive waveform applied to the ultrasonic wave generating element 58, whereupon the surface tension wave is overdamped due to the viscosity of the liquid. In the first amplitude pattern 210, the surface tension wave has an amplitude of n times (for example, 10 times) a prescribed initial value, from t0 to t1 (for example, 0.0 μs to 0.5 μs).

The second amplitude pattern 220 shown in FIG. 2B is an amplitude pattern of steady oscillation, in which the liquid surface is steadily excited successively in time series.

The third amplitude pattern 230 shown in FIG. 2C is an amplitude pattern of an oscillation state (time series oscillation) in which the amplitude of the surface tension wave continuously increases with respect to time. In the third amplitude pattern 230, the surface tension wave has an amplitude of n times (for example, 10 times) a prescribed initial value, from t1 to t2 (for example, 0.5 μs to 1.0 μs).

From a momentary perspective, the first amplitude pattern 210 can be regarded as a stable state, the second amplitude pattern 220 can be regarded as a neutral stable state, and the third amplitude pattern 230 can be regarded as an instable state.

In the first amplitude pattern 210 and the second amplitude pattern 220, if the surface energy of the liquid column (ligament) which is excited on the free liquid surface is increased beyond a particular level, then the liquid column breaks off to form a droplet. Here, the first amplitude pattern 210 is an amplitude pattern which attenuates after a short period of excitation, and hence there is a single liquid column (ligament) excited on the free liquid surface. Therefore, this is suitable for an ejection mode in which a single liquid droplet is to be ejected from the nozzle 51 (individual droplet ejection). On the other hand, the third amplitude pattern 230 is suitable for mist ejection in which a cluster of fine liquid droplets is ejected in the form of a mist from the nozzle 51.

Therefore, in the present embodiment, the first amplitude pattern 210 is used for individual droplet ejection, and the third amplitude pattern 230 is used for mist ejection.

The dependence with respect to time of the amplitude η(t) of the surface tension wave which is attenuated by the viscosity of the liquid is expressed as:

$$\frac{{ⅆ}^{2} η ( t )}{ⅆ {t}^{2}} + β \frac{ⅆ η ( t )}{ⅆ t} + η ( t ) ( {k}^{3} \frac{γ}{ρ} + hk {ω}_{A}^{2} cos {ω}_{A} t ) = 0 , β = \frac{4 μ {k}^{2}}{ρ} , \qquad ( 1 )$$

where k is the spatial wavenumber of the surface tension wave at the meniscus of the liquid, h is the average of the onset amplitude (the amplitude of the surface tension wave at the meniscus of the liquid), ρ is the density of the liquid, γ is the surface tension coefficient of the liquid, ω_{A} is the angular frequency of the liquid surface at the meniscus, and μ is the viscosity coefficient of the liquid.

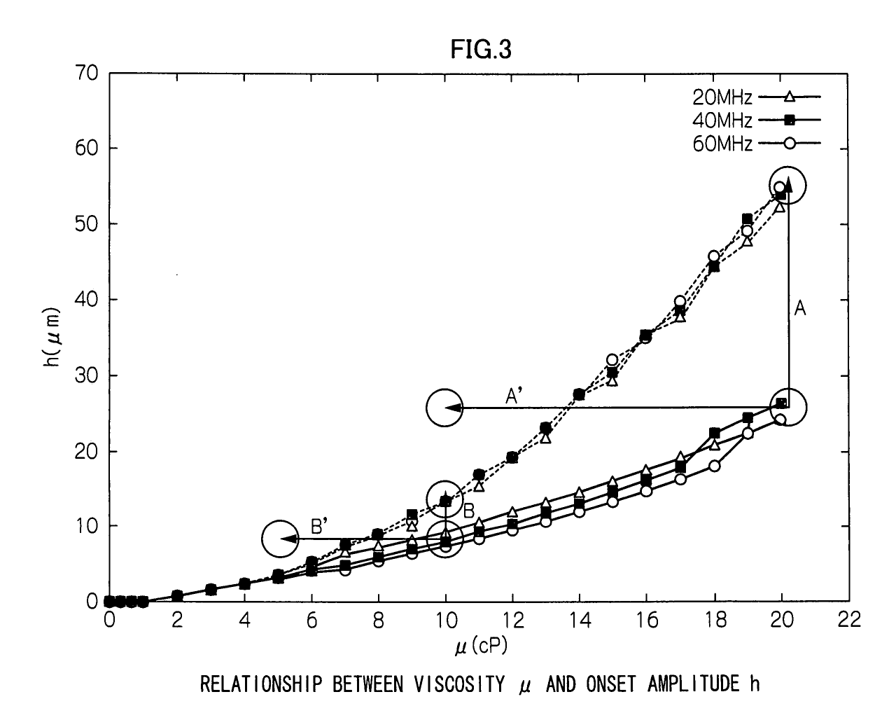

FIG. 3 shows the relationship between the viscosity coefficient μ of the liquid and the onset amplitude h, where the frequency of the drive signal applied to the ultrasonic wave generating element 58 is 20 MHz, 40 MHz or 60 MHz, the solid lines indicate the cases of mist ejection, and the dotted lines indicate the cases of individual droplet ejection.

In FIG. 3, if the viscosity of the liquid is 20 cP, for example, then it is possible to make a transition from the individual droplet ejection mode to the mist ejection mode, by means of path A or path A′.

Here, in the case of the path A, the onset amplitude is increased by approximately 30 μm by raising the voltage of the drive signal applied to the ultrasonic wave generating element 58. However, this involves high energy loss due to dielectric loss.

On the other hand, in the case of the path A′, the viscosity of the liquid (ink) is reduced (by 10 cP) by heating the ink near the meniscus (liquid surface) in the nozzle 51. The path A′ has better energy efficiency than the aforementioned the path A.

The same applies when the viscosity of the liquid is 10 cP: the path B′ which reduces the viscosity of the ink by heating the ink has better energy efficiency than the path B which raises the voltage applied to the ultrasonic wave generating element 58. The same applies to the other viscosity values equal to or exceeding 1 cP.

As described above, there are two typical modes of controlling the liquid ejection head 150 of the present embodiment in such a manner that it is switched between the mist ejection from the nozzle 51 and the individual droplet ejection from the nozzle 51. In the first mode, the viscosity of the liquid near the nozzle 51 is changed by adjusting the temperature of the liquid near the nozzle 51 by means of the heater 80; and in the second mode, the voltage (amplitude) of the drive signal applied to the ultrasonic wave generating element 58 is changed. Of these, the first mode which uses the heater 80 is more desirable from the viewpoint of energy efficiency.

Another mode is also possible which combines both changing of the viscosity of the liquid by using the heater 80, and changing of the voltage (amplitude) of the ultrasonic wave generating element 58.

General Structure of Liquid Ejection Head

Next, the general structure of the liquid ejection head according to the embodiment of the present invention is described.

In order to maximize the resolution of the dots printed on the recording medium, such as paper, the nozzle pitch in the head for ejecting the liquid should be minimized.

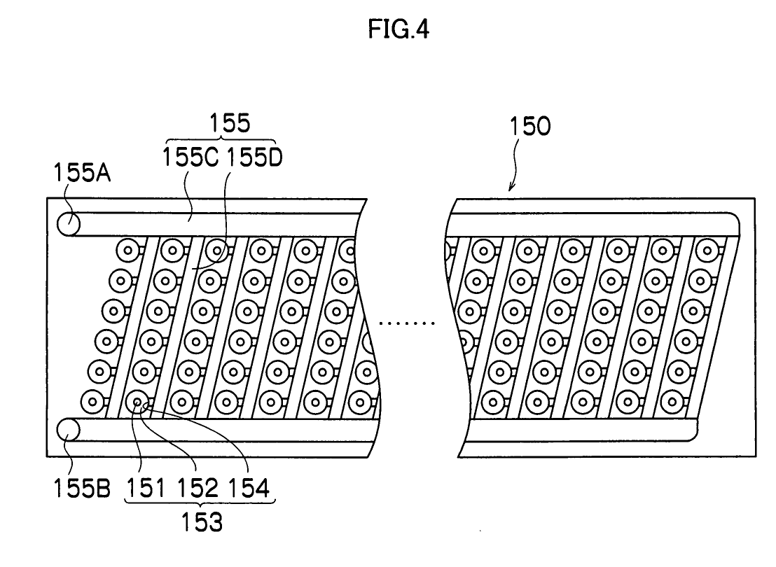

FIG. 4 is a plan view perspective diagram of the liquid ejection head 150 according to the embodiment. As shown in FIG. 4, the liquid ejection head 150 has a structure in which a plurality of ink chamber units (liquid ejection elements) 153, each having a nozzle 151 forming an ink ejection port, an ink chamber 152 corresponding to the nozzle 151, and the like, are disposed in the form of a two-dimensional matrix, and hence the effective nozzle interval (the projected nozzle pitch) as projected in the lengthwise direction of the head 150 (the direction perpendicular to the paper conveyance direction) is reduced (high nozzle density is achieved). In FIG. 4, in order to simplify the drawing, a portion of the ink chamber units 153 is omitted from the drawing.

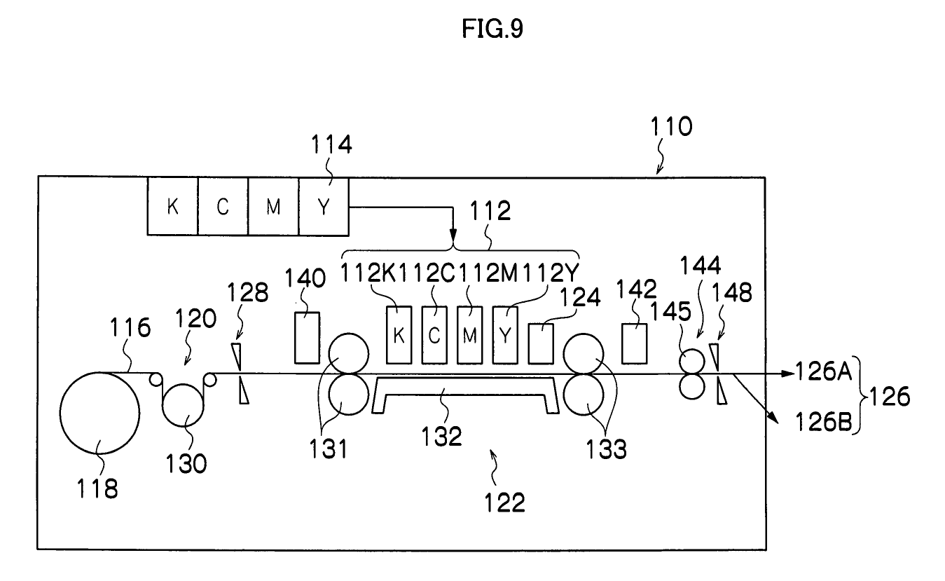

The ink chambers 152 are connected to a common flow channel 155 through individual supply channels 154. The common flow channel 155 is connected to an ink tank which forms an ink source (not shown in FIG. 4 and equivalent to the ink storing and loading unit 114 shown in FIG. 9, which is described hereinafter), through connection ports 155A and 55B, and the ink supplied from the ink tank is distributed and supplied to the ink chambers 152 of the respective channels through the common flow channel 155 in FIG. 4. The reference numeral 155C in FIG. 4 indicates a main channel of the common flow channel 155, and 155D indicates a distributary channel which branches off from the main channel 155C.

To give a brief description of the correspondence of the head 150 shown in FIG. 4 to the composition of the liquid ejection head 150 shown in FIG. 1, the nozzles 151, the liquid chambers 152 and the individual supply channels 154 in FIG. 4 correspond respectively to the nozzles 51, the liquid chambers 52 and the liquid supply ports 16 described with reference to FIG. 1.

The detailed structure of the respective ink chamber units 153 in FIG. 4 is similar to that described with reference to FIG. 1.

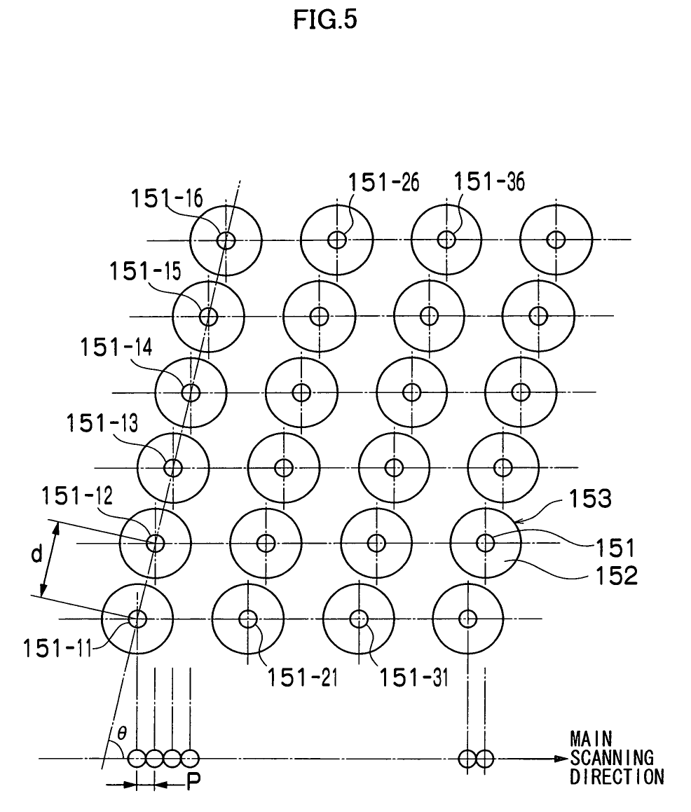

FIG. 5 is an enlarged view showing an enlarged view of a portion of the print head 150 shown in FIG. 4. As shown in FIG. 5, the plurality of ink chamber units 153 are arranged in a lattice configuration in two directions: the main scanning direction and an oblique direction forming a prescribed angle of θ with respect to the main scanning direction. In other words, the plurality of nozzles 151 are arranged in a two-dimensional matrix configuration. By arranging the nozzles in a two-dimensional matrix of this kind, a high density is achieved for the effective nozzle density.

More specifically, by arranging the plurality of ink chamber units 153 at a uniform pitch of d in an oblique direction forming the uniform angle of θ with respect to the main scanning direction, it is possible to treat the nozzles 151 as being equivalent to an arrangement of nozzles at a pitch P (=d×cos θ) in a straight line in the main scanning direction. Consequently, it is possible to achieve a composition which is substantially equivalent to a high-density nozzle arrangement of 2400 nozzles per inch in the main scanning direction.

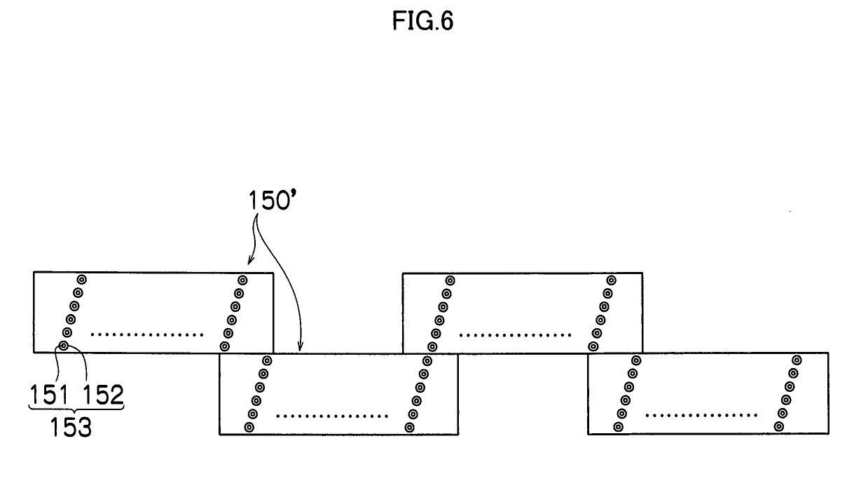

In implementing the present invention, the nozzle arrangement structure is not limited to the embodiment shown in FIGS. 4 and 5. For example, in one mode of a full line head which has a nozzle row extending through a length corresponding to the full width of the recording medium in a direction substantially perpendicular to the conveyance direction of the recording paper 116, instead of the composition shown in FIG. 5, it is possible to compose a line head having a nozzle row of a length corresponding to the full width of the recording medium by joining together, in a staggered matrix arrangement, a plurality of short head blocks 150′, each comprising a plurality of nozzles 151 arranged in a two-dimensional configuration, as shown in FIG. 6, for instance.

Description of Control System

FIG. 7 is a block diagram showing the system configuration embodiment of the image forming apparatus 110. As shown in FIG. 7, the image forming apparatus 110 comprises a communication interface 170, a system controller 172, an image memory 174, a ROM 175, a motor driver 176, a print controller 180, an image buffer memory 182, a head driver 184, and the like.

The communication interface 170 is an image input device for receiving image data sent from a host computer 186. A wired interface such as USB, IEEE1394, Ethernet, or wireless network may be used as the communication interface 170.

The image data sent from the host computer 186 is received by the image forming apparatus 110 through the communication interface 170, and is temporarily stored in the image memory 174.

The system controller 172 is constituted by a central processing unit (CPU) and peripheral circuits thereof, and the like, which controls the whole of the image forming apparatus 110 in accordance with a prescribed program. More specifically, the system controller 172 controls the various sections, such as the communication interface 170, image memory 174, motor driver 176, and the like, and as well as controlling communications with the host computer 186 and writing and reading to and from the image memory 174 and ROM 175, it also generates control signals for controlling the motor 188 of the conveyance system. The motor 188 of the conveyance system is a motor which applies a drive force to the drive rollers of the pairs of conveyance rollers 131 and 133 shown in FIG. 5, for example.

The program executed by the CPU of the system controller 172 and the various types of data which are required for control procedures are stored in the ROM 175. The ROM 175 may be a non-rewriteable storage device, or it may be a rewriteable storage device, such as an EEPROM. The image memory 174 is used as a temporary storage region for the image data, and it is also used as a program development region and a calculation work region for the CPU.

The motor driver (drive circuit) 176 drives the motor 188 of the conveyance system in accordance with commands from the system controller 172.

The print controller 180 functions as a signal processing device which generates dot data for the inks of respective colors on the basis of the input image. More specifically, the print controller 180 is a control unit which performs various treatment processes, corrections, and the like, in accordance with the control implemented by the system controller 172, in order to generate a signal for controlling ink ejection, from the image data in the image memory 174, and it supplies the data (dot data) thus generated to the head driver 184.

The ejection determination unit 124 comprises an image sensor (line sensor or area sensor) for capturing an image of the ejection results of the liquid ejection head 150, and it functions as a device for checking for ejection defects, such as nozzle blockages or displacement of the landing position of the ejected liquid, on the basis of the image read out by the image sensor.

The print controller 180 is provided with the image buffer memory 182; and image data, parameters, and other data are temporarily stored in the image buffer memory 182 when image is processed in the print controller 180. The aspect shown in FIG. 7 is one in which the image buffer memory 182 accompanies the print controller 180; however, the image memory 174 may also serve as the image buffer memory 182. Also possible is an aspect in which the print controller 180 and the system controller 172 are integrated to form a single processor.

To give a general description of the sequence of processing from image inputted to image formation, image data to be formed is inputted from an external source through the communication interface 170, and is accumulated in the image memory 174. At this stage, RGB image data is stored in the image memory 174, for example.

In this image forming apparatus 110, an image which appears to have a continuous tonal graduation to the human eye is formed by changing the density and the dot size of fine dots created by ink (coloring material), and therefore, it is necessary to convert the input digital image into a dot pattern which reproduces the tonal graduations of the image (namely, the light and shade toning of the image) as faithfully as possible. Therefore, original image data (RGB data) stored in the image memory 174 is sent to the print controller 180 through the system controller 172, and is converted to the dot data for each ink color by a half-toning technique, using dithering, error diffusion, or the like, in the print controller 180.

In other words, the print controller 180 performs processing for converting the input RGB image data into dot data for the four colors of K, C, M and Y. The dot data generated by the print controller 180 in this way is stored in the image buffer memory 182.

The head driver 184 outputs drive signals for driving the ultrasonic wave generating elements 58 corresponding to the respective nozzles 151 of the liquid ejection head 150, on the basis of the dot data supplied by the print controller 180 (in other words, the dot data stored in the image buffer memory 182). A feedback control system for maintaining uniform driving conditions in the liquid ejection head may also be incorporated into the head driver 184.

By supplying the drive signals outputted by the head driver 184 to the liquid ejection head 150, the liquid is ejected from the corresponding nozzles 151. By controlling ink ejection from the liquid ejection head 150 in synchronization with the conveyance speed of the recording medium, a prescribed image is formed on the recording medium.

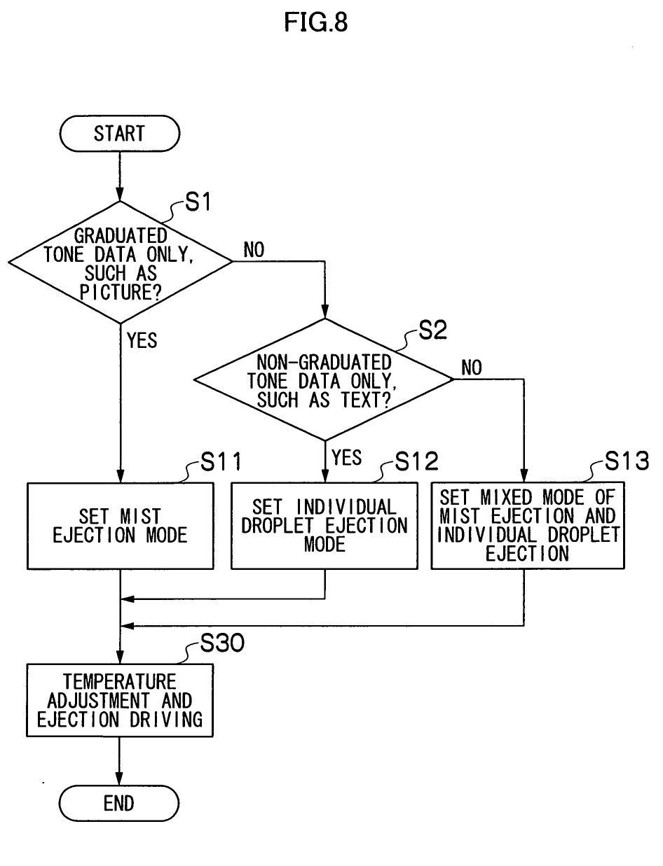

FIG. 8 is a flowchart showing a sequence of an image forming process in which the liquid ejection control method according to the embodiment of the present invention is applied. This image forming process is mainly executed by the system controller 172 and the print controller 180, in accordance with a prescribed program.

Firstly, it is judged (at S1 and S2) whether the image data inputted to the communication interface 170 includes only graduated tone data, such as a picture or photograph, or only non-graduated tone data, such as text, or mixed data which combines both graduated tone data and non-graduated tone data.

If the inputted data includes graduated tone data only, then it is determined that an image is to be formed on the recording medium by means of mist ejection only, and a mist ejection mode is set (S11).

If the inputted data includes non-graduated tone data only, then it is determined that an image is to be formed on the recording medium by means of individual droplet ejection only, and an individual droplet ejection mode is set (S12).

In the case of mixed data, it is judged that an image is to be formed on the recording medium by means of both mist ejection and individual droplet ejection, and a mixed mode combining mist ejection and individual droplet ejection is set (S13).

Thereupon, if necessary, the temperature is adjusted by supplying a drive signal to the heater 80 of the liquid ejection head 150 from the head driver 184, in order that the liquid ejection head 150 assumes the set mode, and furthermore, ejection is operated by supplying drive signals, as necessary, to the ultrasonic wave generating elements 58 of the liquid ejection head 150, from the head driver 184 (S30).

The liquid ejection head 150 comprises the plurality of nozzles 51, and it is possible to individually control each of the nozzles 51, to perform either mist ejection or individual droplet ejection.

For example, in a case where the ejection modes are switched by adjusting the viscosity of the liquid near the nozzle 51 by means of the heater 80, then the head driver 184 drives the heater 80 only in the vicinity of the nozzle 51 that is to be set to mist ejection, whereas the head driver 184 does not drive the heater 80 in the vicinity of the nozzle 51 that is to be set to individual droplet ejection, or the nozzle 51 that is not to perform ejection.

Furthermore, for example, in a case where the ejection modes are switched by adjusting the voltage (amplitude) of the drive signal that is supplied to the ultrasonic wave generating element 80, the voltage of the drive signal applied to the ultrasonic wave generating element 80 corresponding to the nozzle 51 that is to be set to mist ejection is set to a higher level than the voltage of the drive signal applied to the ultrasonic wave generating element 80 corresponding to the nozzle 51 that is set to individual droplet ejection.

FIG. 9 is a general schematic drawing showing an approximate view of an embodiment of the functional composition of the image forming apparatus 110. The image forming apparatus 110 shown in FIG. 9 comprises: a liquid ejection unit 112 having a plurality of liquid ejection heads (hereinafter, called “heads”) 112K, 112C, 112M, and 112Y provided for ink colors of black (K), cyan (C), magenta (M), and yellow (Y), respectively; an ink storing and loading unit 114 for storing inks to be supplied to the heads 112K, 112C, 112M and 112Y; a paper supply unit 118 for supplying recording paper 116 forming a recording medium; a decurling unit 120 for removing curl in the recording paper 116; a belt conveyance unit 122, disposed facing the nozzle face (ink ejection face) of the liquid ejection unit 112, for conveying the recording paper 116 while keeping the recording paper 116 flat; a print determination unit 124 for reading the ejection result produced by the liquid ejection unit 112; and a paper output unit 126 for outputting recorded recording paper (printed matter) to the exterior.

The ink storing and loading unit 114 has ink tanks for storing the inks of K, C, M and Y to be supplied to the heads 112K, 112C, 112M, and 112Y, and the tanks are connected to the heads 112K, 112C, 112M, and 112Y by means of prescribed channels.

In FIG. 9, a magazine for rolled paper (continuous paper) is shown as an embodiment of the paper supply unit 118; however, more magazines with paper differences such as paper width and quality may be jointly provided. Moreover, papers may be supplied with cassettes that contain cut papers loaded in layers and that are used jointly or in lieu of the magazine for rolled paper.

The recording paper 116 delivered from the paper supply unit 118 retains curl due to having been loaded in the magazine. In order to remove the curl, heat is applied to the recording paper 116 in the decurling unit 120 by a heating drum 130 in the direction opposite from the curl direction in the magazine.

In the case of the configuration in which roll paper is used, a cutter (first cutter) 128 is provided as shown in FIG. 9, and the continuous paper is cut into a desired size by the cutter 128. When cut papers are used, the cutter 128 is not required.

After decurling, the cut recording paper 116 is nipped and conveyed by the pair of conveyance rollers 131, and is placed onto a platen 132. A pair of conveyance rollers 133 is also disposed on the downstream side of the platen 132 (the downstream side of the liquid ejection unit 112), and the recording paper 116 is conveyed at a prescribed speed by the joint action of the front side pair of conveyance rollers 131 and the rear side pair of conveyance rollers 133.

The platen 132 functions as a member which holds (supports) the recording paper 116 while keeping the recording paper 116 flat (a recording medium holding device), as well as being a member which functions as the rear surface electrode and the like. The platen 132 in FIG. 9 has a width dimension which is greater than the width of the recording paper 116, and at least the portion of the platen 132 opposing the nozzle surface of the liquid ejection unit 112 and the sensor surface of the ejection determination unit 124 is a horizontal surface (flat surface).

A heating fan 140 is provided in the conveyance path of the recording paper 116, on the upstream side of the liquid ejection unit 112. This heating fan 140 blows heated air onto the recording paper 116 before ink is ejected onto the paper and thereby heats up the recording paper 116. Heating the recording paper 116 immediately before ink ejection has the effect of making the ink dry more readily after landing on the paper.

The liquid ejection heads 112K, 112C, 112M and 112Y of the liquid ejection unit 112 are full line type heads having a length corresponding to the maximum width of the recording paper 116 used with the image forming apparatus 110, and comprising a plurality of nozzles for ejecting ink arranged on a nozzle face through a length exceeding at least one edge of the maximum-size recording paper (namely, the full width of the printable range) (see FIG. 4).

The liquid ejection heads 112K, 112C, 112M and 112Y are arranged in color order (black (K), cyan (C), magenta (M), yellow (Y)) from the upstream side in the feed direction of the recording paper 116, and these respective liquid ejection heads 112K, 112C, 112M and 112Y are fixed extending in a direction substantially perpendicular to the conveyance direction of the recording paper 116.

A color image can be formed on the recording paper 116 by ejecting inks of different colors from the liquid ejection heads 112K, 112C, 112M and 112Y, respectively, onto the recording paper 116 while the recording paper 116 is conveyed by the belt conveyance unit 122.

By adopting a configuration in which the full line heads 112K, 112C, 112M and 112Y having nozzle rows covering the full paper width are provided for the respective colors in this way, it is possible to record an image on the full surface of the recording paper 116 by performing just one operation of relatively moving the recording paper 116 and the liquid ejection unit 112 in the paper conveyance direction (the sub-scanning direction), in other words, by means of a single sub-scanning action. Higher-speed printing is thereby made possible and productivity can be improved in comparison with a shuttle type head configuration in which a liquid ejection head reciprocates in the main scanning direction.

Although the configuration with the KCMY four standard colors is described in the present embodiment, combinations of the ink colors and the number of colors are not limited to those. Light inks, dark inks or special color inks can be added as required. For example, a configuration is possible in which liquid ejection heads for ejecting light-colored inks such as light cyan and light magenta are added. Furthermore, there are no particular restrictions of the sequence in which the liquid ejection heads of respective colors are arranged.

A test pattern or the target image formed by the liquid ejection heads 112K, 112C, 112M, and 112Y of the respective colors is read in by the print determination unit 124, and the ejection result is determined.

A post-drying unit 142 is provided at a downstream stage from the ejection determination unit 124. The post-drying unit 142 is a device for drying the formed image surface, and it may comprise, for example, a heating fan.

A heating/pressurizing unit 144 is disposed following the post-drying unit 142. The heating/pressurizing unit 144 is a device to control the glossiness of the image surface, and the image surface is pressed with a pressure roller 145 having a predetermined uneven surface shape while the image surface is heated, and the uneven shape is transferred to the image surface.

The printed matter generated in this manner is outputted from the paper output unit 126. The target print (i.e., the result of printing the target image) and the test image are preferably outputted separately. In the image forming apparatus 110, a sorting device (not shown) is provided for switching the outputting pathways in order to sort the printed matter with the target print and the printed matter with the test image, and to send them to paper output units 126A and 126B, respectively. When the target print and the test image are simultaneously formed in parallel on the same large sheet of paper, the test image portion is cut and separated by a cutter (second cutter) 148. Although not shown in FIG. 9, the paper output unit 126A for the target prints is provided with a sorter for collecting prints according to print orders.

The present invention is not limited to the above-described embodiments, and various design modifications and improvements may be implemented without departing from the scope of the present invention.

For example, the invention is not limited in particular to a case where a wave motion applied to the liquid in the liquid chamber 52 from the ultrasonic wave generating element 58 of the liquid ejection head 150 travels to the vicinity of the nozzle 51 in form of the direct wave, as shown in FIG. 1, and another composition may also be adopted in which a reflecting plate is arranged and a wave motion that is first reflected to form a reflected wave is concentrated at the vicinity of the nozzle 51.

Furthermore, for example, the invention is not limited in particular to a case where the ultrasonic wave generating elements 58 of the liquid ejection head 150 are arranged on the bottom wall of the liquid chambers 52 so as to oppose the nozzles 51, as shown in FIG. 1, and it is also possible to arrange the ultrasonic wave generating elements 58 in a side wall of the liquid chambers 52, in such a manner that a wave motion is applied to the liquid near the nozzles 51 by reflection.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid ejection apparatus, comprising:
an ejection port through which liquid is ejected;
a heating device which is arranged near the ejection port;
an ultrasonic wave generating element which generates and applies an ultrasonic wave to the liquid near the ejection port so as to be ejected through the ejection port; and
a switching control device which switches between ejection of a cluster of droplets of the liquid through the ejection port and ejection of an individual droplet of the liquid through the ejection port, by changing temperature of the liquid near the ejection port by means of the heating device.

2. A liquid ejection apparatus, comprising:
an ejection port through which liquid is ejected;
an ultrasonic wave generating element which generates and applies an ultrasonic wave to the liquid near the ejection port so as to be ejected through the ejection port; and
a switching control device which switches between ejection of a cluster of droplets of the liquid through the ejection port and ejection of an individual droplet of the liquid through the ejection port, by changing a drive signal applied to the ultrasonic wave generating element.

3. A liquid ejection control method, comprising the steps of:
choosing one of ejection of a cluster of droplets of liquid through an ejection port and ejection of an individual droplet of the liquid through the ejection port; and
switching between the ejection of the cluster of droplets of the liquid through the ejection port and the ejection of the individual droplet of the liquid through the ejection port, by changing temperature of the liquid near the ejection port, according to a result of the choosing step.

4. A liquid ejection control method, comprising the steps of:
choosing one of ejection of a cluster of droplets of liquid through an ejection port and ejection of an individual droplet of the liquid through the ejection port; and
switching between the ejection of the cluster of droplets of the liquid through the ejection port and the ejection of the individual droplet of the liquid through the ejection port, by changing a drive signal applied to an ultrasonic wave generating element which generates and applies an ultrasonic wave to the liquid near the ejection port so as to be ejected through the ejection port, according to a result of the choosing step.
